(19) United States
(12) Patent Application Publication
(10) Pub. No.: US 2014/0143973 A1
(43) Pub. Date: May 29, 2014

(54) WIPING DEVICE, IN PARTICULAR WIPING DEVICE FOR A MOTOR VEHICLE PANE

(71) Applicants: Koen Bex, Jeuk/Limburg Belgien (BE); Helmut Depondt, Kessel-Lo (BE); Dirk Herinckx, Dries-Linter (BE)

(72) Inventors: Koen Bex, Jeuk/Limburg Belgien (BE); Helmut Depondt, Kessel-Lo (BE); Dirk Herinckx, Dries-Linter (BE)

(73) Assignee: ROBERT BOSCH GMBH, Stuttgart (DE)

(21) Appl. No.: 14/129,451

(22) PCT Filed: Jun. 1, 2012
(86) PCT No.: PCT/EP2012/060323

§ 371 Date: Dec. 26, 2013

(30) Foreign Application Priority Data
Jun. 28, 2011 (DE) 102011078185.4

(51) Int. Cl. B60S 1/38

(52) U.S. Cl. CPC B60S 1/381
USPC 15/250.201; 15/250.48

(57) ABSTRACT

The invention relates to a wiping device, in particular a wiping device for a motor vehicle pane, having a retaining unit (10a-10g) with a retaining element (12a-12g), said retaining element (12a-12g) comprising a keder track (70a-70g) that is provided in order to interlockingly accommodate a wiper strip (40a-40g). According to the invention, at least one vertical wall (62a-62g, 64a-64g) of the keder track (70a-70g) forms an acute angle (32a-32g, 34a-34g) with at least one horizontal wall (66a-66g, 68a-68g) of said track (70a-70g).

### BACKGROUND OF THE INVENTION

A wiping device is already known, in particular a wiping device for a motor vehicle pane, comprising a retaining unit which has a retaining element, wherein the retaining element comprises a keder track which is provided to receive a wiper strip positively.

### SUMMARY OF THE INVENTION

The invention is based on a wiping device, in particular a wiping device for a motor vehicle pane, comprising a retaining unit which has a retaining element, wherein the retaining element comprises a keder track which is provided to receive a wiper strip positively.

It is proposed that at least one vertical wall of the keder track encloses an acute angle with at least one horizontal wall of the keder track, whereby the torsional rigidity of the retaining element is able to be advantageously increased. Preferably the angle is less than 85°. Particularly preferably, the angle is less than 80°. “Retaining unit” is intended to be understood here in this context, in particular, as a unit which is provided to connect a spoiler element to a wiper strip. “Retaining element” is intended to be understood here in this context, in particular, as an element which is provided to connect a spoiler element, a spring element and a wiper strip positively together. “Spring element” is intended to be understood in this context, in particular, as a spring elastic element which has at least one dimension which in a normal operating state is able to be resiliently altered by at least 10%, in particular by at least 20%, preferably by at least 30% and particularly advantageously by at least 50%, and which in particular produces a counter-force which is dependent on an alteration of the dimension and preferably proportional to the alteration, said counter-force counteracting the alteration. “Wiper strip” is intended to be understood in this context, in particular, as a strip which is provided to wipe a vehicle pane. Preferably, the wiper strip is formed from a rubber material. “Vertical wall” is intended to be understood in this context, in particular, as a wall which extends substantially perpendicular to a wiping direction. “Horizontal wall” is intended to be understood in this context, in particular, as a wall which extends at least substantially in a main dimensional component parallel to a wiping direction and/or to a surface to be wiped by the wiper strip. “At least substantially” is intended to be understood in this context, in particular, as a deviation of less than 45°, preferably less than 30°. “Provided” is intended to be understood as specifically designed and/or equipped.

In a further embodiment of the invention it is proposed that the wiping device has an intermediate wall which adjoins a longitudinal guide channel of the retaining element and comprises at least one surface which extends parallel to at least one of the horizontal walls, whereby the torsional rigidity may be further increased. “Longitudinal guide channel” is intended to be understood in this context, in particular, as a guide channel which extends parallel to a longitudinal direction of the retaining unit. Preferably, the longitudinal guide channel comprises a free space as well as at least one channel wall defining the free space. “Longitudinal direction” is intended to be understood in this context, in particular, as a direction which extends substantially parallel to a longitudinal dimension of the retaining element. “Longitudinal dimension” is intended to be understood in this context, in particular, as the greatest possible dimension. “Substantially” is intended to be understood in this context, in particular, as a deviation of less than 10°, preferably less than 5°. A “dimension” of an element is intended to be understood in this context, in particular, as a maximum spacing between two points of a vertical projection of the element on a plane.

The wiping device may be designed to be particularly stable if the intermediate wall has at least three surfaces, which enclose two obtuse angles relative to one another.

It is also proposed that at least one of the three surfaces in an assembled state bears positively against the wiper strip, whereby a particularly large bearing surface for the wiper strip may be achieved, together with a compact construction of the retaining unit.

If the retaining element has at least one fastening means, which with a free end faces a longitudinal guide channel of the retaining element and is provided to form a positive connection with a spoiler element, a particularly durable connection may be achieved between a spoiler element and the retaining unit.

If a spoiler element is produced in an extrusion process, production costs may be advantageously saved.

Joints in a main flow region of the spoiler element and/or noise and flow resistance may be avoided if the spoiler element at least partially bears laterally against the retaining element in the region of the longitudinal guide channel.

In a further embodiment of the invention, it is proposed that the spoiler element comprises a longitudinal channel which has a triangular cross section, whereby the material and weight of the retaining element may be saved whilst providing a high degree of strength.

### BRIEF DESCRIPTION OF THE DRAWINGS

Further advantages are revealed from the following description of the drawings. Seven exemplary embodiments of the invention are shown in the drawings. The drawings, the description and the claims contain numerous features in combination. The person skilled in the art will also expediently consider the features individually and combine them to create further useful combinations.

In the drawings:

FIG. 1 shows a sectional view of a wiping device comprising a retaining unit,

FIG. 2 shows a sectional view of a further exemplary embodiment of a wiping device comprising a retaining unit,

FIG. 3 shows a sectional view of a further exemplary embodiment of a wiping device comprising a retaining unit,

FIG. 4 shows a sectional view of a further exemplary embodiment of a wiping device comprising a retaining unit,

FIG. 5 shows a sectional view of a further exemplary embodiment of a wiping device comprising a retaining unit,

FIG. 6 shows a sectional view of a further exemplary embodiment of a wiping device comprising a retaining unit and

FIG. 7 shows a sectional view of a further exemplary embodiment of a wiping device comprising a retaining unit.

### DETAILED DESCRIPTION

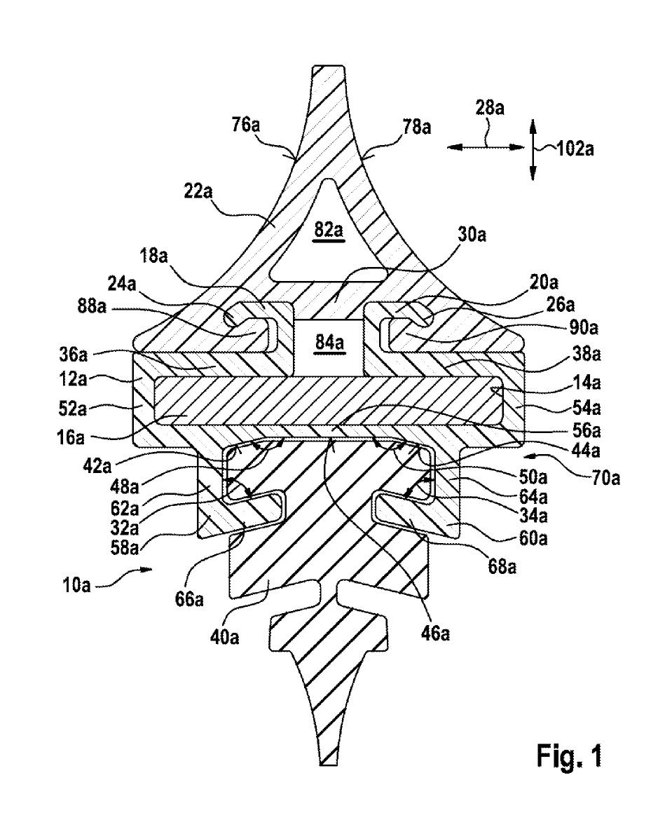

FIG. 1 shows an exemplary embodiment of a wiping device according to the invention comprising a retaining unit 10a having a retaining element 12a which comprises a longitudinal guide channel 14a for guiding a spring element 16a, in a sectional view. The cutting plane extends perpendicular to a longitudinal direction of the retaining element 12a.

The retaining element 12a comprises two fastening means 18a, 20a. The fastening means 18a, 20a are configured integrally with the retaining element 12a. The fastening means 18a, 20a at their free ends 24a, 26a face in directions opposing one another. Moreover, the fastening means 18a, 20a form two channel walls 36a, 38a which adjoin the longitudinal guide channel 14a on a side remote from the wiper strip. The fastening means 18a, 20a are angled back in the region of their free ends 24a, 26a in the direction of the longitudinal guide channel 14a. The ends 24a, 26a are encompassed by a spoiler element 22a. To this end, the spoiler element 22a comprises two bearing bodies 88a, 90a.

To guide the spring element 16a lateral walls 52a, 54a of the longitudinal guide channel 14a adjoin the channel walls 36a, 38a. The channel walls 36a, 38a in this case enclose a right angle with the side walls 52a, 54a. Moreover, an intermediate wall 56a is arranged on the side walls 52a, 54a, said intermediate wall terminating the longitudinal guide channel 14a in the direction of a wiper strip 40a. The side walls 52a, 54a extend from the intermediate wall 56a in a direction opposing the wiper strip 40a. The retaining element 12a has a longitudinal opening 84a which opens the longitudinal guide channel 14a toward the spoiler element 22a.

A keder track 70a is arranged on the intermediate wall 56a, said keder track comprising two guide profiles 58a, 60a. The guide profiles 58a, 60a are integrally formed with the retaining element 12a. The guide profiles 58a, 60a comprise one respective vertical wall 62a, 64a and one respective horizontal wall 66a, 68a. The horizontal walls 66a, 68a in each case enclose with the vertical walls 62a, 64a an acute angle 32a, 34a of 77°. The vertical walls 62a, 64a enclose in each case an angle of 90° relative to the intermediate wall 56a. The guide profiles 58a, 60a at their free ends of the horizontal walls 66a, 68a face in directions facing one another.

The intermediate wall 56a adjoins the longitudinal guide channel 14a of the retaining element 12a and comprises two surfaces 42a, 44a which extend in each case parallel to one of the horizontal walls 66a, 68a. The two surfaces 42a, 44a in each case adjoin a third surface 46a which is arranged between the surfaces 42a, 44a. The surfaces 42a, 44a in each case enclose with the third surface 46a an obtuse angle 48a, 50a of 167°.

The spoiler element 22a is produced in an extrusion process. The spoiler element 22a has two spoiler sides 76a, 78a configured in an outwardly concave manner. To reinforce the spoiler element 22a, a connecting web 30a is provided which connects together the concave spoiler sides 76a, 78a. The connecting web 30a and the spoiler sides 76a, 78a are connected together by a material connection and encompass a longitudinal channel 82a which has a triangular cross section.

The spoiler element 22a is provided to deflect driving wind. The spoiler element 22a forms the bearing bodies 88a, 90a. The bearing bodies 88a, 90a bear positively against the channel walls 36a, 38a and the fastening means 18a, 20a. The spoiler element 22a positively surrounds the fastening means 18a, 20a.

The retaining element 12a is produced in one piece from polyethylene in an extrusion process. In this connection, a person skilled in the art will consider different synthetic materials which appear expedient, such as for example polypropylene, polyamide, polyvinylchloride and/or polystyrene.

The spring element 16a is produced from a spring steel and provided to configure the retaining unit 10a to be elastically deflectable. For assembly, initially the spring element 16a is inserted into the longitudinal guide channel 14a. Subsequently, the wiper strip 40a is pushed into the keder track 70a and forms a positive connection with the retaining element 12a. The surfaces 42a, 44a, 46a bear positively against the wiper strip 40a. The spoiler element 22a is now pushed over the fastening means 18a, 20a and is then positively connected thereto.

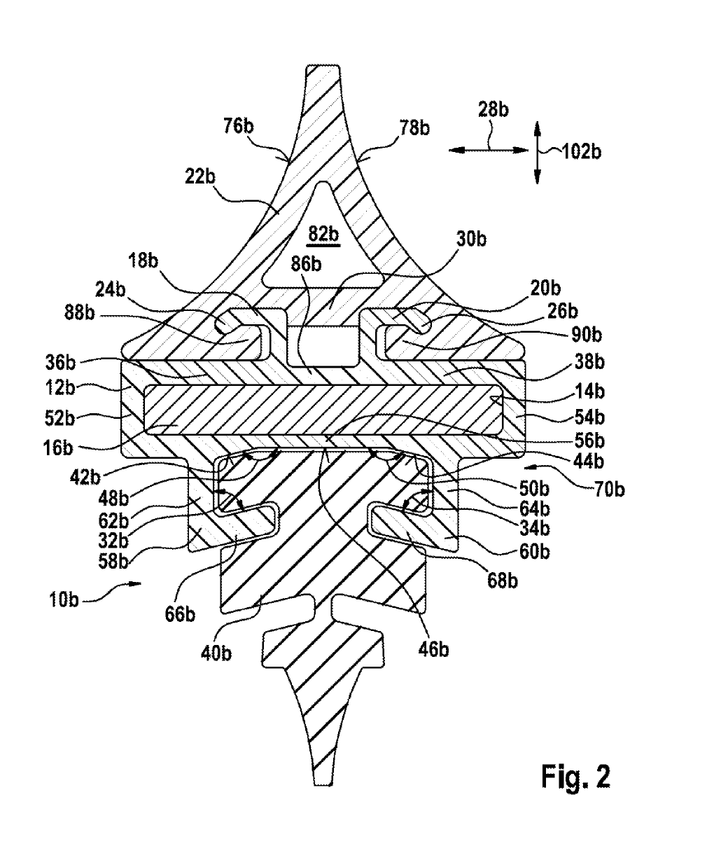

In FIGS. 2 to 7 six further exemplary embodiments of the invention are shown. The following descriptions are substantially limited to the differences between the exemplary embodiments, wherein reference may be made to the description of the first exemplary embodiment relative to components, features and functions which remain the same. To differentiate between the exemplary embodiments, the letter a in the reference numerals of the exemplary embodiment in FIG. 1 is replaced by the letters b to g in the reference numerals of the exemplary embodiments of FIGS. 2 to 7. Relative to components which are identified as the same, in particular relative to components with the same reference numerals, in principle reference may also be made to the drawings and/or the description of the first exemplary embodiment.

FIG. 2 shows a further exemplary embodiment of a wiping device according to the invention comprising a retaining unit 10b having a retaining element 12b which comprises a longitudinal guide channel 14b for guiding a spring element 16b, in a sectional view. The cutting plane extends perpendicular to a longitudinal direction of the retaining element 12b.

The retaining element 12b has two fastening means 18b, 20b. The fastening means 18b, 20b are integrally formed with the retaining element 12b. The fastening means 18b, 20b at their free ends 24b, 26b face in directions opposing one another. Moreover, the fastening means 18b, 20b form two channel walls 36b, 38b which adjoin the longitudinal guide channel 14b on a side remote from the wiper strip. The fastening means 18b, 20b are angled back in the region of their free ends 24b, 26b in the direction of the longitudinal guide channel 14b. The ends 24b, 26b are encompassed by a spoiler element 22b. To this end, the spoiler element 22b comprises two bearing bodies 88b, 90b.

To guide the spring element 16b, lateral walls 52b, 54b of the longitudinal guide channel 14b adjoin channel walls 36b, 38b. The channel walls 36b, 38b in this case enclose a right angle with the side walls 52b, 54b. Moreover, an intermediate wall 56b is arranged on the lateral walls 52b, 54b, said intermediate wall terminating the longitudinal guide channel 14b in the direction of a wiper strip 40b. The lateral walls 52b, 54b extend from the intermediate wall 56b in a direction opposing the wiper strip 40b. A second intermediate wall 86b terminates the longitudinal guide channel 14b in the direction of the spoiler element 22b. Thus the longitudinal guide channel 14b is entirely enclosed.

A keder track 70b is arranged on the intermediate wall 56b, said keder track comprising two guide profiles 58b, 60b. The guide profiles 58b, 60b are integrally formed with the retaining element 12b. The guide profiles 58b, 60b comprise one respective vertical wall 62b, 64b and one respective horizontal wall 66b, 68b. The horizontal walls 66b, 68b in each case enclose with the vertical walls 62b, 64b an acute angle 32b, 34b of 77°. The vertical walls 62b, 64b in each case enclose an angle of 90° relative to the intermediate wall 56b. The guide profiles 58b, 60b at their free ends of the horizontal walls 66b, 68b face in directions facing one another.

The intermediate wall 56b adjoins the longitudinal guide channel 14b of the retaining element 12b and comprises two surfaces 42b, 44b which in each case extend parallel to one of the horizontal walls 66b, 68b. The two surfaces 42b, 44b in each case adjoin a third surface 46b which is arranged between the surfaces 42b, 44b. The surfaces 42b, 44b in each case enclose an obtuse angle 48b, 50b of 167° with the third surface 46b.

The spoiler element 22b is produced in an extrusion process. The spoiler element 22b has two spoiler sides 76b, 78b configured in an outwardly concave manner. To reinforce the spoiler element 22b, a connecting web 30b is provided which connects together the concave spoiler sides 76b, 78b. The connecting web 30b and the spoiler sides 76b, 78b are connected together by a material connection and encompass a longitudinal channel 82b which has a triangular cross section.

The spoiler element 22b is provided to deflect driving wind. The spoiler element 22b forms the bearing bodies 88b, 90b. The bearing bodies 88b, 90b bear positively against the channel walls 36b, 38b and against the fastening means 18b, 20b. The spoiler element 22b positively surrounds the fastening means 18b, 20b.

The retaining element 12b is produced in an extrusion process in one piece from polyethylene. In this connection, a person skilled in the art will consider different synthetic materials which appear expedient, such as for example polypropylene, polyamide, polyvinylchloride and/or polystyrene.

The spring element 16b is produced from a spring steel and is provided to configure the retaining unit 10b to be elastically deflectable. For assembly, the spring element 16b is initially inserted into the longitudinal guide channel 14b. Subsequently, the wiper strip 40b is pushed into the keder track 70b and forms a positive connection with the retaining element 12b. The surfaces 42b, 44b, 46b bear positively against the wiper strip 40b. The spoiler element 22b is now pushed over the fastening means 18b, 20b and then positively connected thereto.

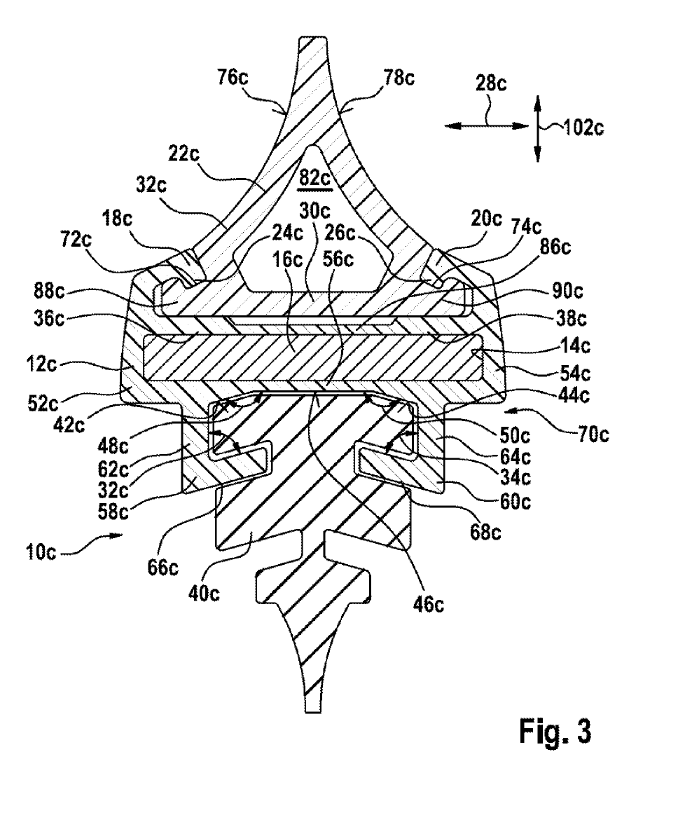

FIG. 3 shows a wiping device according to the invention comprising a retaining unit 10c having a retaining element 12c which comprises a longitudinal guide channel 14c for guiding a spring element 16c, as well as a spoiler element 22c in a sectional view. The cutting plane extends perpendicular to a longitudinal direction of the retaining element 12c.

To guide the spring element 16c, the longitudinal guide channel 14c comprises lateral walls 52c, 54c. Moreover, an intermediate wall 56c is arranged on the lateral walls 52c, 54c, said intermediate wall terminating the longitudinal guide channel 14c in the direction of a wiper strip 40c. The lateral walls 52c, 54c extend from the intermediate wall 56c in a direction opposing the wiper strip 40c. A second intermediate wall 86c terminates the longitudinal guide channel 14c in the direction of the spoiler element 22c. Thus the longitudinal guide channel 14c is entirely enclosed. One respective fastening means 18c, 20c is integrally formed on the lateral walls 52c, 54c, said fastening means in each case facing with a free end 24c, 26c the longitudinal guide channel 14c. The fastening means 18c, 20c are of L-shaped configuration and adjoin the lateral walls 52c, 54c at an obtuse angle of 60°.

A keder track 70c is arranged on the intermediate wall 56c, said keder track comprising two guide profiles 58c, 60c. The guide profiles 58c, 60c are configured integrally with the retaining element 12c. The guide profiles 58c, 60c comprise one respective vertical wall 62c, 64c and one respective horizontal wall 66c, 68c. The horizontal walls 66c, 68c in each case enclose with the vertical walls 62c, 64c an acute angle 32c, 34c of 77°. The vertical walls 62c, 64c in each case enclose an angle of 90° relative to the intermediate wall 56c. The guide profiles 58c, 60c at their free ends of the horizontal walls 66c, 68c face in directions facing one another.

The intermediate wall 56c adjoins the longitudinal guide channel 14c of the retaining element 12c and comprises two surfaces 42c, 44c which in each case extend parallel to one of the horizontal walls 66c, 68c. The two surfaces 42c, 44c in each case adjoin a third surface 46c which is arranged between the surfaces 42c, 44c. The surfaces 42c, 44c in each case enclose an obtuse angle 48c, 50c of 167° with the third surface 46c.

The spoiler element 22c has two spoiler sides 76c, 78c configured in an outwardly concave manner. To reinforce the spoiler element 22c, a connecting web 30c which connects together the concave spoiler sides 76c, 78c is provided. The connecting web 30c and the spoiler sides 76c, 78c are connected together by a material connection and define a longitudinal channel 82c which comprises a triangular cross section.

The spoiler element 22c is provided for deflecting driving wind. Two bearing bodies 88c, 90c are formed from the spoiler element 22c. The bearing bodies 88c, 90c bear positively against channel walls 36c, 38c and against the fastening means 18c, 20c. The spoiler element 22c positively surrounds the fastening means 18c, 20c. The spoiler element 22c has two fastening grooves 72c, 74c which in each case form a positive connection with the fastening means 18c, 20c.

The retaining element 12c is produced in one piece from polyethylene in an extrusion process. In this connection, a person skilled in the art will consider different synthetic materials which appear expedient, such as for example polypropylene, polyamide, polyvinylchloride and/or polystyrene. The spring element 16c is produced from a spring steel and is provided to configure the retaining unit 10c to be elastically deflectable.

For assembly, the spring element 16c is initially inserted into the longitudinal guide channel 14c. Subsequently, the wiper strip 40c is pushed into the keder track 70c and forms a positive connection with the retaining element 12c. The surfaces 42c, 44c, 46c bear positively against the wiper strip 40c. The spoiler element 22c is now pushed over the fastening means 18c, 20c and then positively connected thereto.

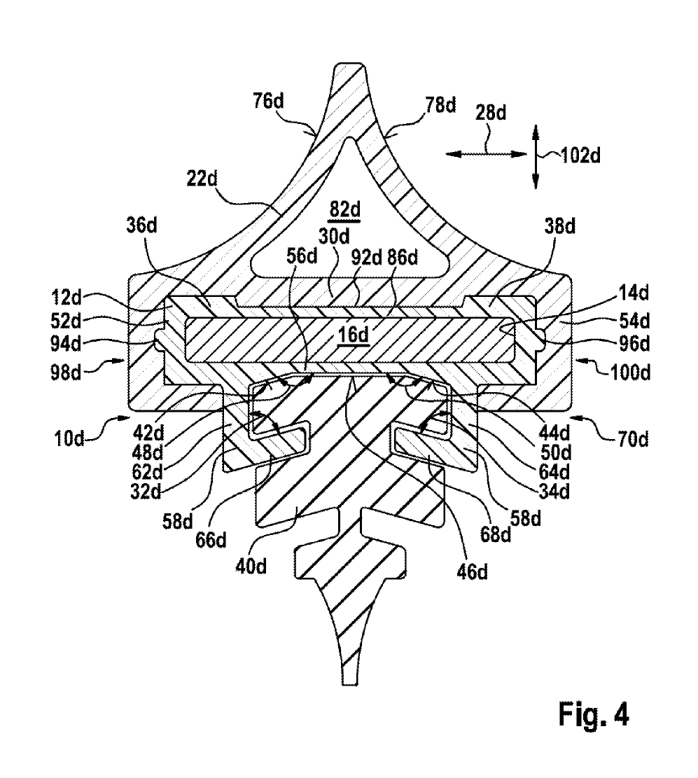

FIG. 4 shows a further exemplary embodiment of a wiping device according to the invention comprising a retaining unit 10d having a retaining element 12d which comprises a longitudinal guide channel 14d for guiding a spring element 16d, as well as a spoiler element 22d, in a sectional view. The cutting plane extends perpendicular to a longitudinal direction of the retaining element 12d.

To guide the spring element 16d, the longitudinal guide channel 14d has lateral walls 52d, 54d. Moreover, an intermediate wall 56d is arranged on the lateral walls 52d, 54d, said intermediate wall terminating the longitudinal guide channel 14d in the direction of a wiper strip 40d. The lateral walls 52d, 54d extend from the intermediate wall 56d in a direction opposing the wiper strip 40d. A second intermediate wall 86d terminates the longitudinal guide channel 14d in the direction of the spoiler element 22d. Thus the longitudinal guide channel 14d is entirely enclosed. In each case a lateral strip 94d, 96d is integrally formed on the lateral walls 52d, 54d.

A keder track 70d is arranged on the intermediate wall 56d, said keder track comprising two guide profiles 58d, 60d. The guide profiles 58d, 60a are integrally formed with the retaining element 12d. The guide profiles 58d, 60d comprise one respective vertical wall 62d, 64d and one respective horizontal wall 66d, 68d. The horizontal walls 66d, 68d in each case enclose with the vertical walls 62d, 64d an acute angle 32d, 34d of 77°. The vertical walls 62d, 64d in each case enclose an angle of 90° relative to the intermediate wall 56d. The guide profiles 58d, 60d at their free ends of the horizontal walls 66d, 68d face in directions facing one another.

The intermediate wall 56d adjoins the longitudinal guide channel 14d of the retaining element 12d and comprises two surfaces 42d, 44d which in each case extend parallel to one of the horizontal walls 66d, 68d. The two surfaces 42d, 44d in each case adjoin a third surface 46d which is arranged between the surfaces 42d, 44d. The surfaces 42d, 44d in each case enclose an obtuse angle 48d, 50d of 167° with the third surface 46d.

The spoiler element 22d is produced in an extrusion process. The spoiler element 22d has two spoiler sides 76d, 78d configured in an outwardly concave manner. To reinforce the spoiler element 22d, a connecting web 30d which connects together the concave spoiler sides 76d, 78d is provided. The connecting web 30d and the spoiler sides 76d, 78d are connected together by a material connection and encompass a longitudinal channel 82d which has a triangular cross section.

The spoiler element 22d is provided for deflecting driving wind. The spoiler element 22d positively surrounds the fastening means 18d, 20d. The connecting web 30d is partially incorporated in a recess 92d of the second intermediate wall 86d and thus forms with the second intermediate wall 86d a positive connection acting in a wiping direction 28d. The spoiler element 22d bears laterally against the retaining element 12d in the region of the longitudinal guide channel 14d.

The retaining element 12d is produced in one piece from polyethylene. In this connection, a person skilled in the art will consider different synthetic materials which appear expedient, such as for example polypropylene, polyamide, polyvinylchloride and/or polystyrene.

The spring element 16d is incorporated in the longitudinal guide channel 14d. The spring element 16d is produced from a spring steel and provided to configure the retaining unit 10d to be elastically deflectable.

For assembly, the spring element 16d is initially inserted into the longitudinal guide channel 14d. Subsequently, the wiper strip 40d is pushed into the keder track 70d and forms a positive connection with the retaining element 12d. The spoiler element 22d is now pushed over the retaining element 12d and is then positively connected thereto.

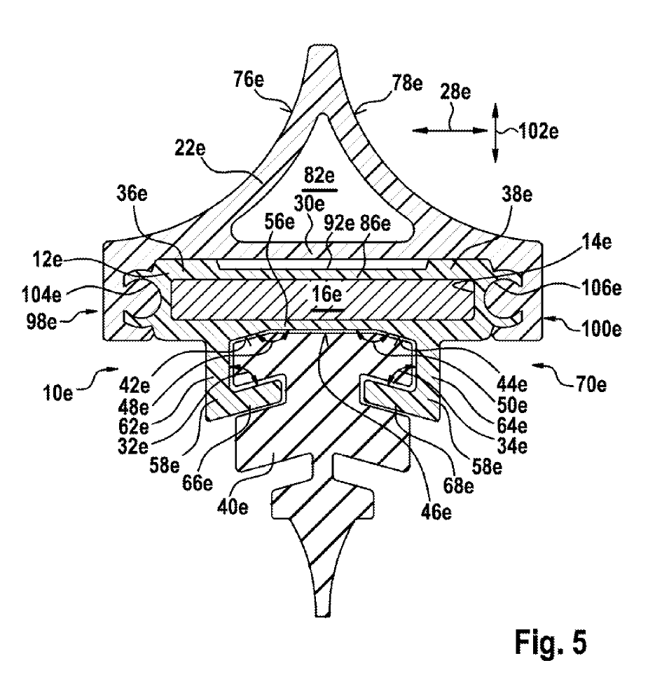

FIG. 5 shows a further exemplary embodiment of a wiping device according to the invention comprising a retaining unit 10e having a retaining element 12e which comprises a longitudinal guide channel 14e for guiding a spring element 16e, as well as a spoiler element 22e, in a sectional view. The cutting plane extends perpendicular to a longitudinal direction of the retaining element 12e.

To guide the spring element 16e, the longitudinal guide channel 14e comprises lateral walls 52e, 54e. Moreover, an intermediate wall 56e is arranged on the lateral walls 52e, 54e, said intermediate wall terminating the longitudinal guide channel 14e in the direction of a wiper strip 40e. The lateral walls 52e, 54e extend from the intermediate wall 56e in a direction opposing the wiper strip 40e. A second intermediate wall 86e terminates the longitudinal guide channel 14e in the direction of the spoiler element 22e. Thus the longitudinal guide channel 14e is entirely enclosed. In each case in a lateral region 98e, 100e an undercut 104e, 106e is arranged in the lateral walls 52e, 54e, said undercut positively connecting the spoiler element 22e to the retaining element 12e in a wiping direction 28e. The undercuts 104e, 106e are of C-shaped configuration and have a cross section tapering toward an opening.

A keder track 70e is arranged on the intermediate wall 56e, said keder track comprising two guide profiles 58e, 60e. The guide profiles 58e, 60e are integrally formed with the retaining element 12e. The guide profiles 58e, 60e comprise one respective vertical wall 62e, 64e and one respective horizontal wall 66e, 68e. The horizontal walls 66e, 68e in each case enclose with the vertical walls 62e, 64e an acute angle 32e, 34e of 77°. The vertical walls 62e, 64e in each case enclose an angle of 90° relative to the intermediate wall 56e. The guide profiles 58e, 60e at their free ends of the horizontal walls 66e, 68e face in directions facing one another.

The intermediate wall 56e adjoins the longitudinal guide channel 14e of the retaining element 12e and comprises two surfaces 42e, 44e which in each case extend parallel to one of the horizontal walls 66e, 68e. The two surfaces 42e, 44e in each case adjoin a third surface 46e which is arranged between the surfaces 42e, 44e. The surfaces 42e, 44e enclose in each case an obtuse angle 48e, 50e of 167° with the third surface 46e.

The spoiler element 22e is produced in an extrusion process. The spoiler element 22e has two spoiler sides 76e, 78e configured in an outwardly concave manner. To reinforce the spoiler element 22e, a connecting web 30e which connects together the concave spoiler sides 76e, 78e is provided. The connecting web 30e and the spoiler sides 76e, 78e encompass a longitudinal channel 82e which has a substantially triangular cross section.

The spoiler element 22e is provided for deflecting driving wind. The spoiler element 22e bears laterally against the retaining element 12e in the region of the longitudinal guide channel 14e in a positive manner. The spoiler element 22e also bears in the region of the longitudinal guide channel 14e against one side of the retaining element 12e which faces the wiper strip 40e. The spoiler element 22e thus bears positively in the region of the longitudinal guide channel 14e against the retaining element 12e and encompasses the longitudinal guide channel 14e. In this case, the spoiler element 22e engages in the undercuts 104e, 106e and entirely fills up said undercuts. Thus in the lateral regions 98e, 100e the retaining element 12e forms a positive connection with the spoiler element 22e acting in the wiping direction 28e and in a vertical direction 102e.

The retaining element 12e is produced in one piece from polyethylene. In this connection, a person skilled in the art will consider different synthetic materials which appear expedient, such as for example polypropylene, polyamide, polyvinylchloride and/or polystyrene.

The spring element 16e is incorporated in the longitudinal guide channel 14e. The spring element 16e is produced from a spring steel and provided to configure the retaining element 10e to be elastically deflectable.

For assembly, the spring element 16e is initially inserted into the longitudinal guide channel 14e. Subsequently, the wiper strip 40e is pushed into the keder track 70e and forms a positive connection with the retaining element 12e. The spoiler element 22e is now pushed over the retaining element 12e and then positively connected thereto.

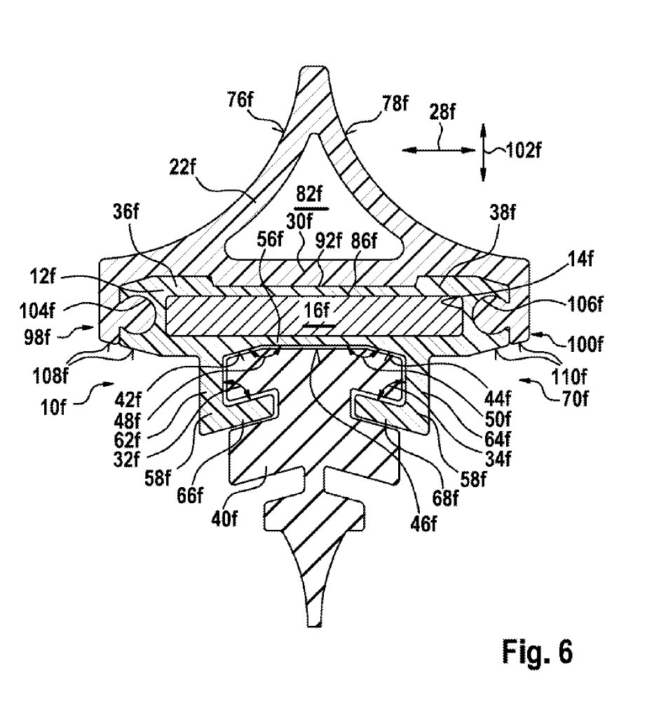

FIG. 6 shows a further exemplary embodiment of a wiping device according to the invention comprising a retaining unit 10f having a retaining element 12f, which comprises a longitudinal guide channel 14f for guiding a spring element 16f, and comprising a spoiler element 22f, in a sectional view. The cutting plane extends perpendicular to a longitudinal direction of the retaining element 12f.

The wiping device corresponds substantially to the exemplary embodiment shown in FIG. 5.

In one respective lateral region 98f, 100f, the retaining element 12f and the spoiler element 22f have a surface 108f, 110f which extends parallel to a horizontal wall 66f, 68f of a keder track 70f of the retaining element 12f. The surface 108f, 110f in each case encloses an angle of 13° with a wiping direction 28f.

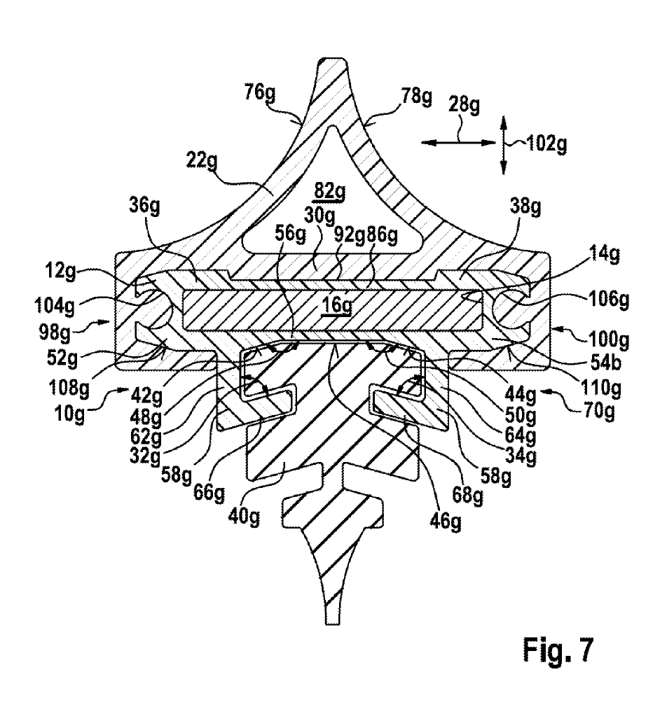

FIG. 7 shows a further exemplary embodiment of a wiping device according to the invention comprising a retaining unit 10g having a retaining element 12g which comprises a longitudinal guide channel 14g for guiding a spring element 16g, and comprising a spoiler element 22g, in a sectional view. The cutting plane extends perpendicular to a longitudinal direction of the retaining element 12g. The wiping device corresponds substantially to the exemplary embodiment shown in FIG. 6.

In one respective side region 98g, 100g, the retaining element 12g has a surface 108g, 110g which extends parallel to a horizontal wall 66g, 68g of a keder track 70g of the retaining element 12g. The surface 108g, 110g in each case encloses an angle of 13° with a wiping direction 28g.

The spoiler element 22g bears in the region of the longitudinal guide channel 14g against one side of the retaining element 12g which faces a wiper strip 40g. In this case, the spoiler element 22g also bears positively against the surfaces 108g, 110g of the retaining element 12g. The spoiler element 22g also bears against vertical walls 62g, 64g of the keder track 70g.

1. A wiping device, comprising a retaining unit (10a-10g) which has a retaining element (12a-12g), wherein the retaining element (12a-12g) comprises a keder track (70a-70g), which is provided to receive a wiper strip (40a-40g) positively, characterized in that at least one vertical wall (62a-62g, 64a-64g) of the keder track (70a-70g) encloses an acute angle (32a-32g, 34a-34g) with at least one horizontal wall (66a-66g, 68a-68g) of the keder track (70a-70g).

2. The wiping device as claimed in claim 1, characterized in that the angle (32a -32g) is less than 80°.

3. The wiping device as claimed in claim 1, characterized by an intermediate wall (56a-56g) which adjoins a longitudinal guide channel (14a-14g) of the retaining element (12a-12g) and comprises the at least one surface (42a-42g, 44a -44g) which extends parallel to at least one of the horizontal walls (66a-66g, 68a-68g).

4. The wiping device as claimed in claim 3, characterized in that the intermediate wall (56a-56g) comprises at least three surfaces (42a-42g, 44a-44g, 46a-46g) which enclose two obtuse angles (48a-48g, 50a-50g) relative to one another.

5. The wiping device as claimed in claim 4, characterized in that at least one of the three surfaces (42a-42g, 44a-44g, 46a-46g) in an assembled state bears positively against the wiper strip (40a-40g).

6. The wiping device as claimed in claim 1, characterized in that the retaining element (12a-12c) has at least one fastening means (18a-18c, 20a-20c) which with a free end (24a-24c, 26a-26c) faces a longitudinal guide channel (14a-14c) of the retaining element (12a-12c) and is provided to form a positive connection with a spoiler element (22a-22c).

7. The wiping device as claimed in claim 1, characterized by a spoiler element (22a-22g) which is produced in an extrusion process.

8. The wiping device as claimed in claim 7, characterized in that the spoiler element (22d-22g) at least partially bears laterally against the retaining element (12d-12g) in a region of the longitudinal guide channel (14d-14g).

9. The wiping device at least as claimed in claim 7, characterized in that the spoiler element (22a; 22b; 22d-22g) comprises a longitudinal channel (82a; 82b; 82d-82g) which has a triangular cross section.

10. A retaining unit (10a-10g) of a wiping device as claimed in claim 1.
